(19) United States
(12) Patent Application Publication
(10) Pub. No.: US 2004/0210420 A1
(43) Pub. Date: Oct. 21, 2004

(54) Lightweight alarm manager on web browser and service method thereof, and method of providing alarm information therefor

(76) Inventor: Jong-Ky Lee, Suwon-city (KR)

Correspondence Address: Robert E. Bushnell, Suite 300, 1522 K Street, N.W., Washington, DC, 20005, US

(21) Appl. No.: 10/772,392

(22) Filed: Feb. 6, 2004

(30) Foreign Application Priority Data
Feb. 12, 2003 (KR) 10-2003-8926

(51) Int. Cl. G06F 11/30

(52) U.S. Cl. 702/186

(57) ABSTRACT

An alarm manager on a Web browser for transmitting alarm manager provided by NMS (Network Management System) by simply operating as a dynamic HTML through a HTML document object provided by the Web browser, without a separate loading program, and a service method thereof, and a method of providing alarm information to the alarm manager. The service method includes the steps of: creating a header frame, a contents frame, and a data frame on the Web browser, in response to an alarm manager service from a user; requesting, at the data frame, the NMS to provide alarm information periodically, and managing the alarm information being requested when the alarm information is received; periodically checking, at the contents frame composed of dynamic HTML, whether the alarm information in the data frame is properly managed; and obtaining, at the contents frame, the alarm information being managed by the data frame, composing the alarm information in a data table system, and displaying the alarm information for the user to be able to confirm the alarm info.

### CLAIM OF PRIORITY

This U.S. nonprovisional patent application claims priority under 35 U.S.C. § 119 of Korean Patent Application 2003-8926 filed on Feb. 12, 2003, the entire contents of which is hereby incorporated by reference.

### BACKGROUND OF INVENTION

1. Field of the Invention

The present invention relates to a lightweight alarm manager on a web browser like IE (Internet Explorer) and a service method thereof, and a method of retrieving alarm information from an NMS (Network Management System) to an alarm manager for display, a method for managing alarm information in the NMS server, the NMS being real time mode, the providing of the alarm information being on the basis of DHTML (Dynamic HTML) wherein a client's loading is low and a separate loading time is not required.

2. Description of Related Art

For a better understanding of the present invention and the related art thereof, provided below are definitions of terms related to the invention:

NMS (Network Management System): NMS is a computer system for supporting network management, and has following functions. (i) NMS collects status of network, alarm and traffic data from an exchange, and stores the data; (ii) NMS calculates network management parameters or statistical data; (iii) NMS controls traffic inflow of an exchange under a command; and (iv) NMS controls a network control terminal and a network monitor of a network management center. ITU-T Recommendation E.411 calls NMS as ‘network management operations system’.

Dynamic HTML: Dynamic HTML (Hypertext Markup Language) is a collective term indicating a new HTML tag, style sheet and programming, which has more animation, compared to the old version HTML, and makes it possible to design a more sensitive web page to user interaction.

Much of the dynamic HTML is listed in HTML 4.0. To give simple examples of a dynamic HTML page, (i) text colors change when a user moves the mouse pointer over the text, (ii) the user can “drag” the image to a different position of the web page, and so on. Using the dynamic HTML, it is possible to make web documents look like desktop application programs or multimedia products, and operate accordingly.

Applet: Applet means a small application program. Before the World Wide Web was introduced, an applet used to indicate small programs that are basically provided in addition to Microsoft window, such as notepad (notepad.exe) or paint (pbrush.exe). On the Web, using Java, the object-oriented programming language, an applet is a small program that can be provided to a user, together with a web page. A Java applet is capable of performing simple tasks including animation, simple calculations and things that can be carried out without the user making a special request to a server.

ActiveX: ActiveX is a name that ‘Microsoft’ gave to the strategic object-oriented programming techniques and toolkit. Its major technique is COM (Component Object Model). If COM is used in network together with directory and other additional support, it is DCOM (Distributed Component Object Model). The ActiveX is a very important component created at the time of developing a program that runs within ActiveX environment. Since ActiveX runs on any part of the ActiveX network, it can be said to be one independent program by itself. This component is called ActiveX control. In fact, ActiveX was introduced by Microsoft, as an attempt to compete with Java techniques of ‘Sun Microsystems’. Thus, it is safe to say that ActiveX control is on substantially equal position to the Java applet.

Resource: In general, resource means a certain item (or object) that can be used. For instance, devices like printers, disk drives and memory can be resource. In the majority of operating systems like ‘Microsoft Window’ or ‘Macintosh’, resources indicate data or routines for programs. Particularly, these resources are sometimes called ‘system resources’.

XML (Extensible Markup Language): XML is a page technique language that an association named ‘World Wide Web consortium (W3C)’ is standardizing for the purpose of replacing XML with HTML, the hypertext markup language. Mostly, it is abbreviated to XML. XML not only extends a link function being used in HTML, but also optimizes SGML (Standard Generalized Markup Language) for Internet use, so XML takes merits of both HTML and SGML. Further, XML is a flexible way to create common information formats and share both the format and the data on the World Wide Web, intranets, and elsewhere. For example, computer makers might agree on a standard or common way to describe the information about a computer product (processor speed, memory size, and so forth) and then describe the product information format with XML. Such a standard way of describing data would enable a user to send an intelligent agent (a program) to each computer maker's Web site, gather data, and then make a valid comparison. XML can be used by any individual or group of individuals or companies that wants to share information in a consistent way.

DOM (Document Object Model): DOM is a programming interface standard currently being developed by the World Wide Web Consortium (W3C). DOM helps a programmer to make or modify XML documents to program objects. HTML and XML are simply methods for expressing documents into data formats. Such documents, similar to program objects, have their own contents or data embedded in objects. Further, the documents can be a great help for securing control over document manipulation. The documents, like objects, can accompany object-oriented procedures called the ‘method’. In short, DOM is strategic, open efforts for deciding how to provide the programming control on documents. Also, The Document Object Model offers two levels of interface implementation DOM Core, which supports XML and is the base for the next level, and DOM HTML, which extends the model to HTML documents. Any HTML or XML element (with the possibility of a few exceptions) will be individually addressable by programming.

DTD (Document Type Definition): DTD is a specific definition, conforming to SGML standard. DTD is another standard accompanied by document, which subsets paragraphs of the document, identifies the title of a subject, and identifies markup that describes how to process respectively. When DTD and document are emailed, the document can be processed anywhere a DTD reader (or SGML compiler) is available. Once the document is processed, it can be displayed on a screen or printed out as originally intended. This means that one SGML compiler is capable of servicing (processing) other markup codes and many different documents with related definitions. Referring to DTD, the compiler properly displays the document on the screen or prints it out.

JSP (Java Server Page): JSP is a technique for controlling contents or design of a Web page by using a sublet (a small program running within a server). Sun Microsystems, the Java developer, says JSP technique is a sublet API (Application Program Interface). JSP is a match for ASP (Active Server page) technique developed by Microsoft. JSP calls Java programs to be run within a Web server, while ASP includes a script to be interpreted by a script interpreter (e.g. VBScript or Jscript) before a Web page is sent to the user.

Thread: A thread is placeholder information associated with a single use of a program that can handle multiple concurrent users. From the program's point-of-view, a thread is the information needed to serve one individual user or a particular service request. If multiple users are using the program or concurrent requests from other programs occur, a thread is created and maintained from each of them. The thread allows a program to know which user is being served as the program alternately gets re-entered on behalf of different users.

Lightweight: In information technology, the term lightweight is sometimes applied to a program, protocol, device, or anything that is relatively simpler or faster or that has fewer parts than something else. For example, in programming, a lightweight thread is a program thread (an instance of use) that takes fewer instructions to keep track of than an ordinary thread, thus enabling the program to handle more users at the same time at an acceptable performance level.

The related art is now described below: As Internet has proliferated globalwide, more people have grown accustom to the Web environment and an efficient management of Web-based network has become very important. Generally, among many functions provided by Web-based NMS is an alarm manager that is supposed to provide data dynamically by implementing programming languages like Java, visual basic, or C/C++, using an applet or ActiveX control, and running in a Web browser.

This is because the alarm manager, to provide alarm information dynamically, should have a dynamic support function for GUI (Graphical User Interface) and a communication function for collecting data from a server.

However, to perform appropriate functions, the above techniques require a separate loading program, which involves starting up a virtual machine, downloading a corresponding GUI component, loading a downloaded component, and so on, consequently taking much time for downloading. In short, the techniques are relatively heavy and slow, and use much more client's resources than other functions based on pure HTML.

As an alternative, a client could receive accumulated alarm information from the server on a regular basis using a refresh tag function of the HTML, without using the separate loading program, and continuously provides the data to the web browser. In such case, however, thousands of accumulated data might need to be transmitted at once. Even though the accumulated data could be successfully transmitted, when the data is displayed, the browser blinks every time, and this only makes it difficult for the user to figure out the data.

### SUMMARY OF THE INVENTION

It is therefore an object of the present invention to provide a novel alarm manager and a novel process to overcome the above problems and/or disadvantages and to provide at least the advantages described hereinafter.

It is also an object of the present invention to provide an improved design for an alarm manager.

It is yet another object of the present invention to provide an improved process for transferring alarm information from an NMS server to an alarm manager for display.

It is further an object of the present invention to provide a novel process inside a server for extracting pertinent alarm information and then sending this pertinent alarm information to the alarm managers for display.

It is also an object of the present invention to solve the foregoing problems by providing a lightweight alarm manager in a Web browser and a service method thereof, capable of transmitting alarm information provided by NMS (Network Management System) to users, simply operating the alarm manager as a dynamic HTML through a HTML document object provided by the Web browser, without applying a separate loading program.

It is also an object of the present invention to provide a method of providing alarm information to a lightweight alarm manager that offers alarm info, being operated as a dynamic HTML.

These and other objects may be achieved by an lightweight alarm manager running in a Web browser to be applied to a computer connected to NMS (Network Management System) over network, the alarm manager having a header frame for fixing a title label of the alarm manager, a data frame for receiving alarm information from the NMS through the network and managing the alarm information in XML (Extensible Markup Language) format and a contents frame composed of dynamic HTML (Hypertext Markup Language) for reading the alarm information being managed in the data frame and providing a user with the alarm information in a data table system.

Another aspect of the present invention provides a service method of the alarm manager to be applied to a computer connected NMS (Network Management System) through network, the service method enabling alarm information transferred from the server to the alarm manager to be displayed to the user. The method involves first creating a header frame, a contents frame, and a data frame on the Web browser, in response to an alarm manager service from a user. Then, the alarm manager requests the server to send alarm information periodically to the data frame of the alarm manager. The contents frame composed of dynamic HTML checks the data frame for alarm information and then the contents frame makes a table containing the alarm information for display.

Another aspect of the invention provides a method within the NMS (Network Management System) server for managing alarm information. The method includes receiving an alarm information request from an alarm manager through network; confirming session information related to the alarm manager, and obtaining time information for composing alarm information to be transmitted to the alarm manager, retrieving alarm information from a database on the basis of the time information, converting the alarm information to XML format, and transmitting the alarm information in XML format to the alarm manager.

Regarding the above method, additional steps may be added as desired. For example, the service thread in the server can, upon receiving an HTTP request from an alarm manager, can check to see if a session information on that alarm is present in the JSP context, and if not present, create a new session information. Also, the session information is updated if any new pertinent information is found in the database in the server.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is the configuration of network system according to the principles of the present invention;

FIG. 2 is a diagram describing the structure of a lightweight alarm manager that runs in a Web browser according to the principles of the present invention;

FIG. 3 is a diagram describing the configuration of an NMS server and data flow in a method of providing alarm information to the lightweight alarm manager according to the principles of the present invention;

FIG. 4 is a flow chart illustrating a service method of the lightweight alarm manager running in the Web browser according to the principles of the present invention;

FIG. 5 is a flow chart illustrating the method in an NMS server that provides alarm information to the lightweight alarm manager according to the principles of the present invention; and

FIG. 6 depicts one embodiment of a display displaying alarm information for a user via the lightweight alarm manager running in the Web browser according to the principles of the present invention.

### DETAILED DESCRIPTION OF THE INVENTION

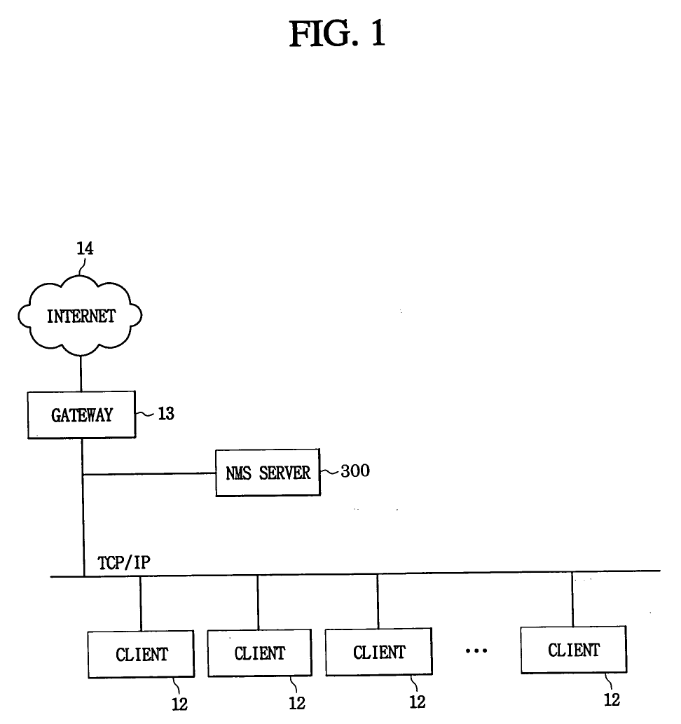

Turning now to the figures, FIG. 1 illustrates a configuration of a network system to which the present invention is applied. Referring to FIG. 1, the network system includes a NMS (Network Management System) server 300, a client 12, a gateway 13, and Internet 14. Particularly in FIG. 1, LANs (Local Area Network) and Internet 14 for connecting the networks are distinguished from each other. The gateway 13 is a device for connecting separated networks, that is, interconnecting networks. In short, the gateway 13 is a point where one network enters another network. Besides the gateway, routers, hubs, or switches may instead be used for interconnecting networks.

The client 12 is a device that allows a user to exchange data (or information) through a networked PC (Personal Computer). A lightweight alarm manager of the present invention is applied to the client 12, providing the user with alarm information generated from network equipments. The NMS server 300 is a computer system for supporting network management. All network related alarm information is offered to the lightweight alarm manager.

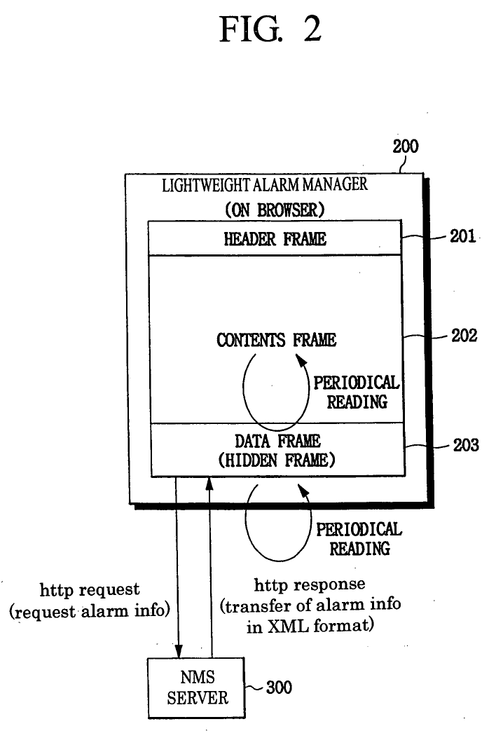

FIG. 2 is a diagram describing the structure of the lightweight alarm manager 200 that runs in a Web browser according to a preferred embodiment of the present invention. A lightweight alarm manager resides in each client 12 of FIG. 1. With reference to FIG. 2, the lightweight alarm manager 200 is networked to the NMS server 300 and provides alarm information to the user. To execute necessary processing, the alarm manager 200 is configured with three HTML frames, i.e. a header frame 201, a contents frame 202, a data frame 203.

The header frame 201 is used for fixing a title label to the lightweight alarm manager 200. The contents frame 202 tabulates alarm information in the data frame 203 and provides the data to the user. In other words, the contents frame 202 regularly reads alarm information from the data frame 203.

The data frame 203 is a hidden frame, meaning that the user cannot see it. The data frame 203 receives alarm information in XML format from the NMS server 300 on a regular basis and manages the alarm information in the XML format. To receive the alarm information in XML format from the NMS server 300 periodically, the data frame 203 transmits a HTTP (HyperText Transfer Protocol) request (or a request for alarm information) to the NMS server 300, and then in return receives a HTTP response (or alarm information in XML format) from the NMS server 300.

The contents frame 202 is mainly composed of dynamic HTML, and provides GUI by handling a table object of the HTML provided by the Web browser like Internet Explorer. Operating the dynamic HTML timer, XML DOM data in the data frame 203 is read on a regular basis. Then a row is simply added to this table, using the attributes of the table object of the HTML provided in the Web browser like Internet Explorer, and eventually the data is displayed.

In date frame 203, XML data is periodically updated. The web browser supports API making XML parsing possible. Among the API is an API supported by dynamic HTML. This is why contents frame 202 reads XML alarm info into data frame 203 while being characterized as being composed of dynamic HTML.

The XML data in the data frame 203 has DTD as illustrated below in Table 1:

TABLE 1

<!DOCTYPE alarm_information [
<!ELEMENT alarm(severity, eventtime, alarm_id, dn, contents)>
<!ELEMENT severity (#PCDATA)>
<!ELEMENT eventtime (#PCDATA)>
<!ELEMENT alarm_id (#PCDATA)>
<!ELEMENT dn (#PCDATA)>
<!ELEMENT contents (#PCDATA)>
]>

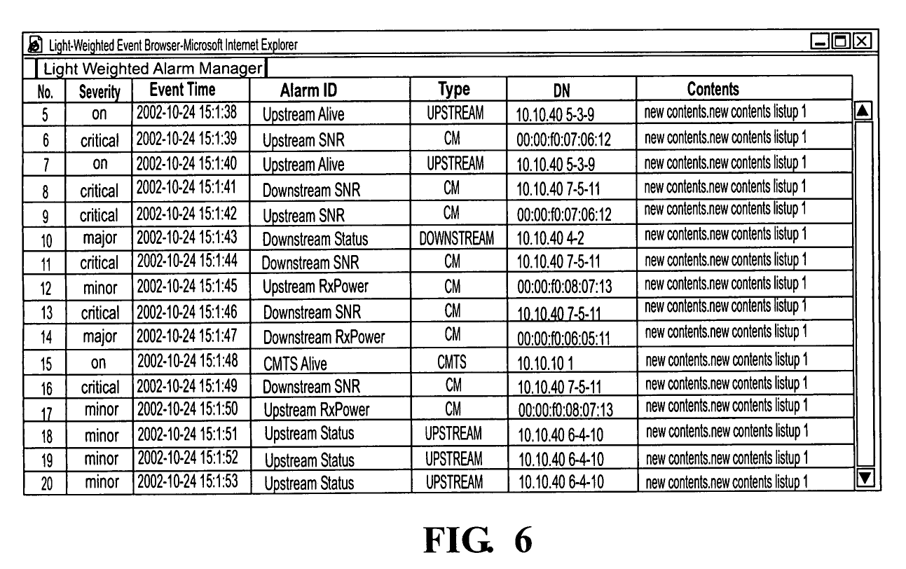

Each alarm information to be provided to the user by the lightweight alarm manager 200 is illustrated in Table 1. As illustrated in Table 1, the XML data in the data frame 203 includes the {severity} of the alarm, the time {eventtime} when the alarm is raised, alarm ID {alarm_id}, components of network equipment, {dn}, where the alarm is raised, and contents of the alarm {contents}. Further description on them will be provided later with reference to FIG. 6.

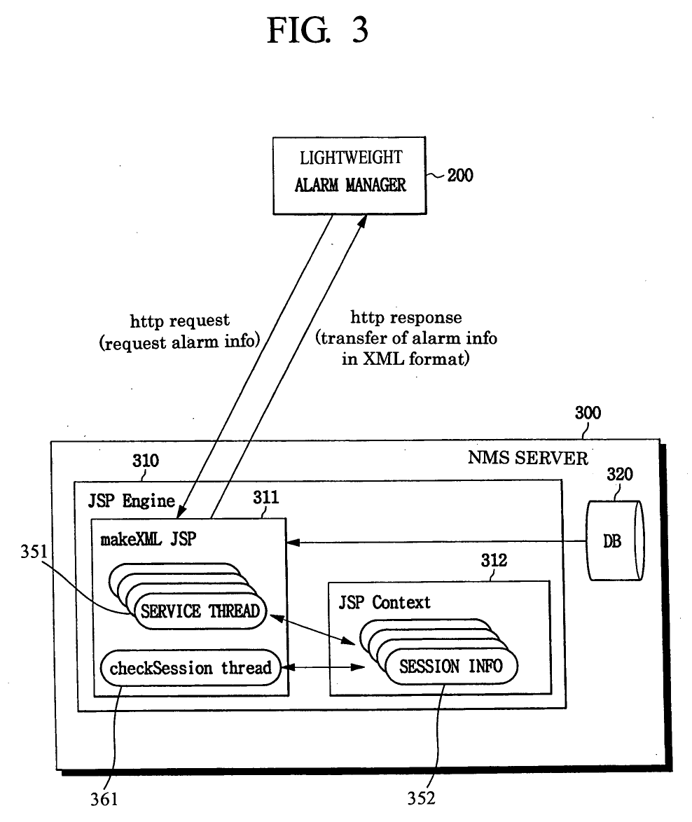

FIG. 3 is a diagram describing the configuration of an NMS server 300 and data flow in the method of providing alarm information to the lightweight alarm manager 200 according to a preferred embodiment of the present invention. The major configuration for transmitting alarm information from the NMS server 300 to the alarm manager 200 is realized through the application of JSP technique.

The NMS server 300 includes a JSP engine 310 and a DB (database) 320. The JSP engine 310 is mounted with a makeXML JSP (XML make JSP) 311 for transmitting XML data to the data frame 203 of the lightweight alarm manager 200, and a JSP context 312. In the makeXML JSP 311, there is a service thread 351 for offering alarm information at the request of each of the networked lightweight alarm managers 200, and a checkSession thread 361 for managing (or checking) existence of respective lightweight alarm managers 200.

The makeXML JSP 311 regularly receives a HTTP request from each of the lightweight 8 managers 200, and confirms a final date and time to extract new alarm information from session information 352 in the JSP Context 312. Having the final date and time as the starting point, the makeXML JSP 311 queries data from the DB 320 and constructs a XML document with the data and transmits the XML document to the data frame 203 of the lightweight alarm manager 200. In other words, makeXML JSP 311 converts the alarm info into XML format and then sends this alarm info in XML format to data frame 203 of alarm manager 200 upon receipt of an http request (or a request for alarm info) from alarm manager 200.

The JSP Context 312 stores session information 352 about lightweight alarm managers 200. Session information 352 is a memory. However, session information can be saved as some readable medium. As illustrated in Table 2, each session information is composed of NMS user information, wherein the NMS is currently using the alarm manager 200, and information about time when a corresponding alarm manager 200 raises a final alarm.

TABLE 2

<!DOCTYPE session_information [
<!ELEMENT session(userid, lasttime)>
<!ELEMENT userid (#PCDATA)>
<!ELEMENT curtime (#PCDATA)>
<!ELEMENT lasttime (#PCDATA)>
]>

In Table 2, ‘curtime’ is when current session information is updated.

The checkSession thread 361 periodically searches session information 352 in the JSP Context 312, and if the ‘curtime’ is already passed, decides that the corresponding alarm manager 200 is complete, and eventually deletes or destroys related session info 352.

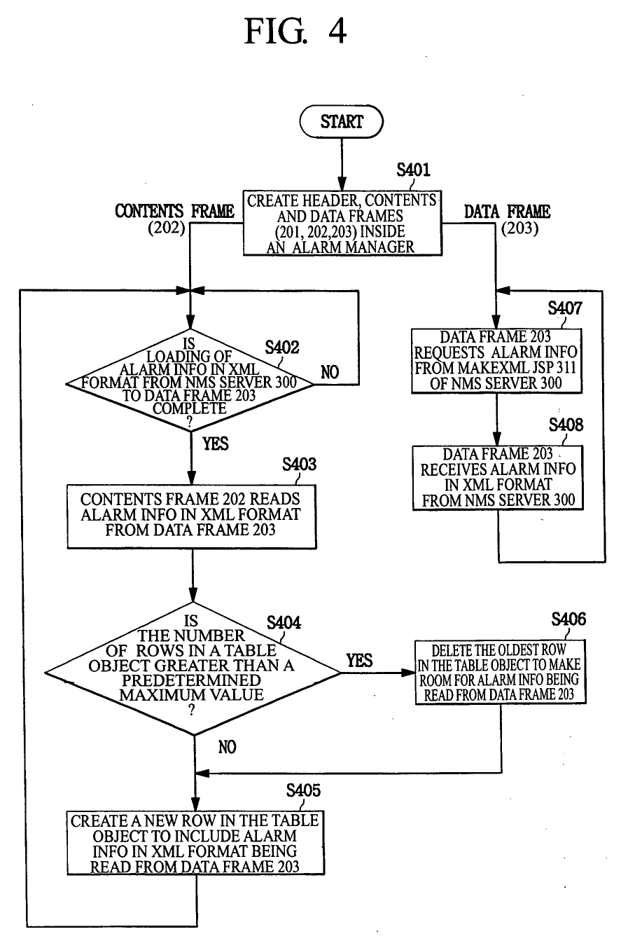

FIG. 4 is a flow chart illustrating a service method of the lightweight alarm manager running in the Web browser according to a preferred embodiment of the present invention. The following describes creation of the header frame 201, the contents frame 202, and the data frame 203 in the lightweight alarm manager 200, and operations performed in each of these frames. In this discussion, the header frame will not be discussed since header frame 201 is used only to provide a header label.

The contents frame 202 provides alarm information to the user through the Web browser like Internet Explorer, and operation principles involved here are now explained. At first, the contents frame 202 performs an iterative reading function as soon as the HTML page is loaded, to read the data frame 203 repeatedly. Next, the content frame 202 checks the number of current rows in the table object provided by the Web browser like Internet Explorer, and finds out if the number of current rows is greater than a maximum number of rows that can be maintained in the table object of the lightweight alarm manager 200. As a result, if there are more rows than the maximum allowed, old records in the table object are deleted, starting from the oldest record, until the number of remaining rows becomes less than or equal to the maximum number of rows to be maintained.

In addition, the contents frame 202 confirms whether alarm data in XML format is properly loaded into the data frame 203 in a hidden state. If the alarm data in XML format is properly loaded, the contents frame 202 reads the data from data frame 203. Of course, if the alarm data in XML format is not properly loaded into data frame 203, the contents frame 202 continuously confirms this until the alarm data is completely loaded into data frame 203.

Lastly, the contents frame 202 creates new rows in the table object of the HTML, to include the data being read. Contents frame 202 then writes this data into the table object, thereby 11 allowing the user to see the newly received alarm info.

To explain how the data frame 203 operates, the data frame 203, using a meta tag provided by the HTML, calls makeXML JSP 311 in the NMS server 300 on a regular basis. Also, the data frame 203 receives changed (or updated) alarm information from NMS server 300 and keeps this data to itself within data frame 203.

The procedure of the service method of the lightweight alarm manager is now described, with reference to FIG. 4. To begin with, having received a request from the user to use the lightweight alarm manager 200, the client creates the header frame 201, the contents frame 202, and the data frame 203, and operates the frames (S401). Each of the frames in operation plays a role given to itself.

Now turning to the contents frame 202 and the left hand side of FIG. 4, the contents frame 202 checks whether the loading of alarm data in XML format from NMS server 300 to data frame 203 is complete (S402). That is, the contents frame 202 checks whether the alarm information in the XML format is finished being transmitted from the NMS server 300 to the data frame 203 of alarm manager 200. If it turns out that the loading of this alarm data into the data frame 203 is not complete, the step S402 for checking the completion of the loading of this data is continually performed until finished.

When the contents frame 202 confirms that XML the loading of this data to data frame 203 is complete, the contents frame 202 then reads this alarm data in XML format from the data frame 203 (S403). That is, the contents frame 202 reads the alarm information transmitted from the NMS server 300.

Next, the contents frame 202 checks whether the number of existing rows in the table object is greater than a maximum number of rows allowed (S404). If it turns out that the number of existing rows is not greater than the maximum number of rows allowed, the contents frame 202 creates new rows in the table object to include the alarm information being read from the data frame 203 (S405). Then, the process goes back to step S402 where it is again determined whether the loading of alarm information in XML format from NMS server 300 to data frame 203 in alarm manager 200 is complete.

On the other hand, if the number of existing rows in the table object exceeds the maximum allowed in step S404, then old rows, starting from the oldest, are deleted from the table object (S406). Then, a new row is created in the table object to include the alarm information currently being read from the data frame 203 (S405). Then, the process reverts back to step S402 to determine whether the loading of alarm information in XML format from NMS server 300 to data frame 203 is complete.

The operational procedure in the data frame 203 is now explained in conjunction with the right hand side of FIG. 4. The data frame 203 stores the alarm information downloaded from the NMS server 300, and provides this data when the contents frame 202 starts operating. Also, the data frame 203 periodically calls the makeXML JSP 311 of the NMS server 300 and transmits an alarm information request (HTTP request) (S407). Later, the data frame 203 receives the alarm information in the XML format from the makeXML JSP 311 of NMS server 300 (HTTP response) (S408). The above steps (S407 and S408) in the data frame 203 are repeatedly conducted while the steps S402 through S406 in the contents frame 202 are repeatedly conducted.

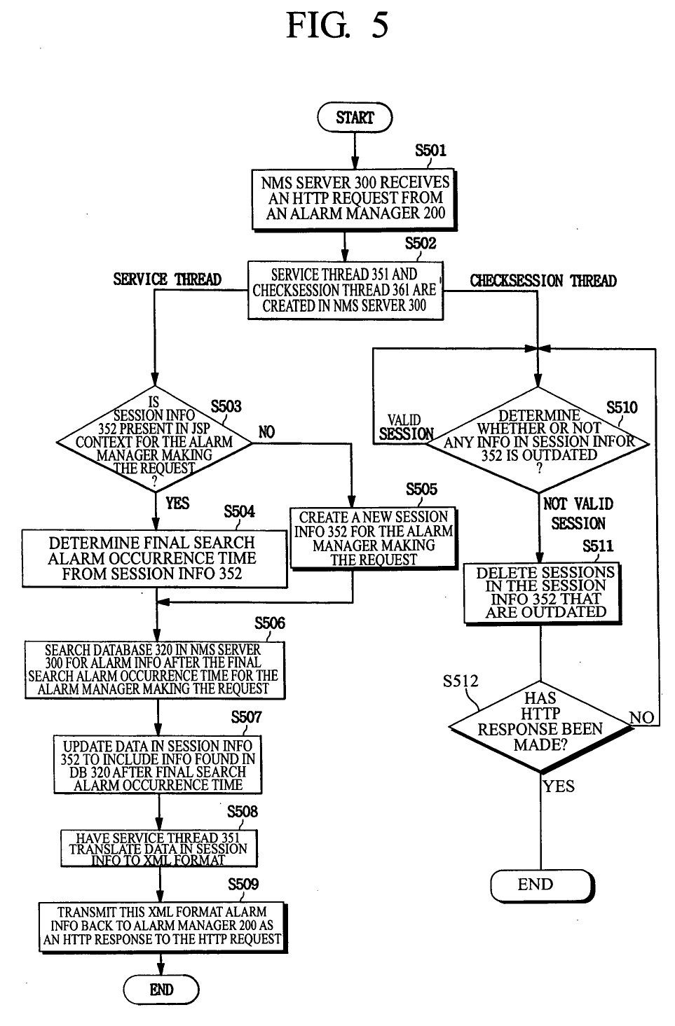

Turning now to FIG. 5, FIG. 5 is a flow chart illustrating the method of providing alarm information to the lightweight alarm manager 200 according to a preferred embodiment of the present invention. Providing alarm information for the lightweight alarm manager 200 is carried out in the NMS server 300, more particularly by the makeXML JSP 311. The following describes operational procedure being carried out in each thread of the makeXML JSP 311 in the NMS server 300.

Service thread 351 is first explained. The makeXML JSP 311 in the NMS server 300 receives a HTTP request from the data frame 203 of the lightweight alarm manager 200, requesting the alarm information from NMS server 300 (S501). In response to the request from the lightweight alarm manager 200, a service thread 351 and a checkSession thread 361 are created (S502).

Operational procedures being conducted in the service thread 351 and in the checkSession thread 361 are now described separately in conjunction with the left hand side of FIG. 5. To see the operational procedure being conducted in the service thread 351 first, the service thread 351, in response to the HTTP request from the lightweight alarm manager 200, confirms whether the JSP Context 312 has session information 352 related to the lightweight alarm manager 200 (S503). If the session information 352 related to the lightweight alarm manager 200 exists in JSP context 312, the service thread 351 extracts a final search alarm occurrence time from the session information 352 in the JSP Context 312 (S504). Then, the service thread 351 searches alarm information out from the DB 320, after extracting the final search alarm occurrence time from the session information 352 in JSP context 312 (S506).

If it turns out that the session information related to the lightweight alarm manger 200 does not exist in the JSP Context 312, a new session in relation to the lightweight alarm manager 200 is created (S505), and alarm information is then searched out and returned from the DB 320 (S506).

After retrieving alarm information from the DB 320, the service thread 351 then updates the session information 352 of the JSP Context 312 to include information found in DB 320 but not present in the session information 352 (S507).

Also, the service thread 351 converts the alarm information into the XML format (S508), to provide the alarm information in XML format to the data frame 203 of the lightweight alarm manager 200 during the HTTP response in response to the HTTP request (S509).

Now, the operational procedure in the checkSession thread will be explained. The checkSession thread 361 originally deletes session information 352 that goes beyond an expiration time being given, and also confirms this continually (S510) and deletes a corresponding session (S511). The checkSession thread 361 serves to clean up the session information 352 in the JSP context 312 and removes any old alarm information that is present beyond the expiration time for that information. That is, the checkSession thread 361 checks an update date of the session information 352 in the JSP Context 312 (S510). If the corresponding session is a valid session within the expiration time, the checkSession thread 361 repeats the step (S510) for checking the session information 352 update date. But if the corresponding session is not valid within the expiration time, the checkSession thread 361 deletes the corresponding session (S511). This checking of the session information 352 occurs while steps S503 through S509 occur. When the HTTP response of step S509 is made, the checking of the session information 352 by checkSession 361 in step S510 ceases at step S512.

Turning now to FIG. 6, FIG. 6 illustrates one embodiment of alarm information provided to the user through the lightweight alarm manager running in the Web browser according to the present invention. As illustrated in FIG. 6, each alarm information provided by the lightweight alarm manager to the user is composed of {severity} of the alarm, {eventtime} when the alarm is raised, alarm ID {alarm_id}, components of network equipment, {dn}, where the alarm is raised, and contents of the alarm {contents}. These data are provided to the user according to a designated sort system.

As discussed before, the method of the present invention can be implemented to a program and stored in computer-readable recording medium (e.g. CD ROM, LAM, ROM, Floppy disk, Hard disk, Magneto-optical disk etc.).

In conclusion, the present invention can be advantageously used in that a client is capable of dynamically providing alarm information to a user within a fast loading time, without incurring large load, by driving a lightweight alarm manager based on a dynamic HTML in a Web browser.

While the present invention has been particularly shown and described with reference to exemplary embodiments thereof, it will be understood by those skilled in the art that the foregoing and other changes in form and details may be made therein without departing from the spirit and scope of the present invention.

What is claimed is:

1. A lightweight alarm manager running in a Web browser, to be applied to a computer connected to NMS (Network Management System) over network, comprising:
a header frame fixing a title label of the alarm manager;
a data frame receiving alarm information from the NMS through the network and managing the alarm information in XML (Extensible Markup Language) format; and
a contents frame having dynamic HTML (Hypertext Markup Language) for reading the alarm information being managed in the data frame and providing a user with the alarm information in a data table system.

2. The alarm manager of claim 1, wherein the contents frame handles a table object of a HTML provided by the Web browser, and provides a GUI (Graphical User Interface).

3. The alarm manager of claim 1, wherein the contents frame provides the alarm information that is comprised of {severity} of the alarm, {eventtime} when the alarm is raised, alarm ID {alarm_id}, components of network equipment, {dn}, where the alarm is raised, and contents of the alarm {contents}.

4. A service method of a lightweight alarm manager running in a Web browser, to be applied to a computer connected NMS (Network Management System) through network, the service method comprising the steps of:
receiving a request from a user to use the alarm manager;
creating a header frame, a contents frame, and a data frame on the Web browser in the alarm manager, in response to an alarm manager service request from a user;
requesting, at the data frame, that the NMS provide alarm information periodically to the data frame;
managing the alarm information in the alarm manager when the alarm information is received by the data frame;
periodically checking, by the contents frame made up of dynamic HTML, whether the alarm information in the data frame is being properly managed;
accessing and obtaining, by the contents frame, the alarm information being managed by the data frame;
constructing a data table of the alarm information being managed by the data frame; and
displaying the alarm information to the user.

5. The method of claim 4, wherein the requesting step is comprised of the sub-steps of:
requesting the NMS connected to the data frame through the network to provide alarm information periodically;
receiving alarm information in a XML format from the NMS; and
managing the received alarm information in the XML format.

6. The method of claim 4, wherein the accessing and obtaining, constructing and displaying steps comprise:
obtaining, by the contents frame, the alarm information in XML format from the NMS;
managing, by the data frame, the received alarm information in the data frame;
simply adding a row to a table object, by the contents frame, using attributes of the table object of a HTML provided by the Web browser; and
displaying the alarm information being obtained using the table object.

7. The method of claim 5, wherein the accessing and obtaining, constructing and displaying steps comprise:
obtaining, by the contents frame, the alarm information in XML format from the NMS;
managing, by the data frame, the received alarm information in the data frame;
simply adding a row to a table object, by the contents frame, using attributes of the table object of a HTML provided by the Web browser; and
displaying the alarm information being obtained using the table object.

8. The method of claim 6, wherein the step for adding a row by the contents frame comprises sub-steps of:
checking when a number of current rows in the table object provided by the Web browser is greater than a predetermined number of rows;
deleting the oldest record when the number of current rows in the table object provided by the Web browser is greater than the predetermined number;
creating a new row in the table object comprising the alarm information read by the contents frame; and
displaying the alarm information of the table object when the number of current rows in the table object provided by the Web browser is not greater than the predetermined number of rows to be maintained.

9. The method of claim 7, wherein the step for adding a row by the contents frame comprises sub-steps of:
checking when a number of current rows in the table object provided by the Web browser is greater than a predetermined number of rows;
deleting the oldest record when the number of current rows in the table object provided by the Web browser is greater than the predetermined number;
creating a new row in the table object comprising the alarm information; and
displaying the alarm information of the table object when the number of current rows in the table object provided by the Web browser is not greater than the predetermined number of rows to be maintained.

10. A method of providing alarm information to a lightweight alarm manager running in a Web browser, the method comprising the steps of:
receiving, at NMS (Network Management System), an alarm information request from an alarm manager via a network;
confirming, at the NMS, session information related to the alarm manager, and obtaining time information used to form an alarm information packet to be transmitted to the alarm manager;
obtaining, at the NMS, additional alarm information from a database in the NMS, the additional information being based on the time information, the additional information being added to the packet;
converting the packet into XML format at the NMS, and
transmitting the packet of alarm information in XML format to the alarm manager.

11. The method of claim 10, further comprising the step of managing, at the NMS, the session information related to each of the alarm managers via a checkSession thread.

12. A method of providing alarm information to a lightweight alarm manager running in a Web browser, the method comprising the steps of:
receiving, at NMS (Network Management System), an alarm information request from an alarm manager via a network;
creating, at the NMS, a service thread for providing alarm information at a request of the alarm manager, and a checkSession thread for managing session information related to the alarm manager;
determining, at the service thread, whether session information related to the alarm manager exists is present in the NMS, and when the session information is not present, creating a new session information, and when the session information is present, extracting a final search alarm occurrence time from the session information;
based on the alarm occurrence time, obtaining, via the service thread, additional alarm information by searching a database in the NMS and updating the session information accordingly with information found in the database, said additional alarm information being based on the alarm occurrence time;
converting, at the service thread, the alarm information into an XML format, and transmitting the alarm information to the alarm manager as a response to the request; and
checking, at the checkSession thread, an update date of the session info, and deleting the session information when the session information is not valid.

13. The method of claim 12, wherein the session information has information about the alarm manager that sent the request, information about a user using the alarm manager, and information about time of final alarm occurrence of the alarm manager.

14. A NMS(Network Management System) server adapted to serve a plurality of alarm managers, the NMS server comprising:
a JSP (Java Server Page) engine comprising a makeXML JSP adapted to transmit XML data to a data frame of one of said plurality of lightweight alarm managers, and a JSP context adapted to store session information about said plurality of lightweight alarm managers; and
a database comprising alarm information.

15. The NMS server of claim 14, wherein the makeXML JSP provides a service thread that is adapted to offer alarm information at the request of each of the plurality of lightweight alarm managers, and a checkSession thread adapted to manage (or check) an existence of each of the plurality of lightweight alarm managers.

16. The NMS server of claim 15, wherein the makeXML JSP regularly receives a HTTP request from each of the lightweight managers, and confirms a final date and time to extract new alarm information from the session information in the JSP Context.

17. The NMS server of claim 14, wherein the makeXML JSP, using a final date and time as a starting point, queries data from the database and constructs a XML document representing the data from the database and transmits the XML document to a data frame of one of the plurality of lightweight alarm managers.

18. The NMS server of claim 14, wherein the JSP context comprising the stored session information is compriesed of NMS user information using the plurality of alarm managers, and information about a time when a corresponding one of said plurality of alarm managers raises a final alarm.
